(19) United States
(12) Patent Application Publication
(10) Pub. No.: US 2026/0299914 A1
(43) Pub. Date: Oct. 1, 2026

(54) METHOD FOR CUSTOMIZING A SENSOR FUNCTION AND SMART DEVICE INCLUDING A SENSOR

(71) Applicant: SONY SEMICONDUCTOR SOLUTIONS CORPORATION, KANAGAWA (JP)

(72) Inventors: DONGSHENG YAN, BEIJING (CN); FENG GAO, BEIJING (CN); HONGXIA WANG, BEIJING (CN); BOJIE ZHANG, BEIJING (CN)

(21) Appl. No.: 19/483,429

(22) PCT Filed: Apr. 28, 2024
(86) PCT No.: PCT/CN2024/090359

§ 371 Date: Nov. 11, 2025

(30) Foreign Application Priority Data
May 16, 2023 (CN) 202310552597.X

(51) Int. Cl. G06F 8/61; G06F 8/41

(52) U.S. Cl. CPC G06F 8/61; G06F 8/41

(57) ABSTRACT

The present invention relates to a method for customizing a sensor function based on Wasm technology, which comprises: providing a mathematical model trained for a sensor in a smart device and a post-processing program customized for the mathematical model, wherein the post-processing program is configured to perform post-processing on an output data of the mathematical model; deploying the mathematical model in the smart device; compiling the post-processing program into a Wasm program and deploying the Wasm program in the smart device; providing, in the smart device, an interface defined based on WASI specifications, via which the Wasm program can access and operate the sensor. In addition, the present invention relates to a smart device comprising a sensor, wherein the function of the sensor is customized using the method according to the present invention.

### CROSS-REFERENCE TO RELATED APPLICATION

The present application claims the benefit of the Chinese patent application No. 202310552597.X filed with the China National Intellectual Property Administration on May 16, 2023, which is incorporated herein by reference in its entirety.

### TECHNICAL FIELD

The present invention relates to the field of computers, in particular to a technology for customizing a sensor function based on the Wasm technology.

### BACKGROUND ART

In the field of intelligent technology, sensors can be used in autonomous driving, equipment detection, environmental detection, logistics detection, security detection, health detection, smart home appliances, retail industry, health care, agriculture, smart cities, etc.

A sensor in a smart device contains calculation models or AI models that are developed, trained, or customized for specific purposes. These models are collectively referred to as mathematical models in this disclosure. The sensor can provide a calculation or inference result based on its detection by using a corresponding mathematical model. Here, the format of the calculation or inference result may vary depending on the model.

For different formats, the smart device needs to post-process the calculation or inference result on site to obtain the desired information. A typical way of post-processing is to convert the calculation or inference result into a readable, visible and structured metadata character stream.

As mentioned above, different models may output calculation or inference results in different formats. As a result, it becomes difficult to customize respective post-processing functions for the models. The post-processing functions need to be provided by model developers. However, model developers usually are not familiar with the software and hardware architecture of the smart device, and usually pay more attention to the logic of post-processing and its adaptation to the model.

In order to customize the post-processing function, developers should know how to recognize the data in the specific model and how to communicate with the sensor. However, the developers usually are not familiar with the working environment of the smart device, and therefore it is difficult to deploy a matching post-processing function that can run on any smart device. Various ways to customize post-processing functions using Wasm technology exist currently, but they all have some problems to a greater or lesser extent.

For example, the Camera Remote SDK, a software development kit provided by SONY, does not provide a universal API for sensor control. The Waft (WebAssembly Framework for Things), a new development framework proposed by Alibaba engineers, does not provide an API for accessing AI sensors or general sensors to read data. US20220198071A1 mentions that Wasm technology is suitable for task sharing to reduce the burden on the main computing node, but no method is provided for task simulation on child nodes. CN202210944973, CN202210096203, etc. lack sandbox control, have security issues, or do not comply with WASI specifications.

In addition, the current model development is highly dependent on several mainstream software frameworks, such as tensorflow, pytorch, onnx, etc. On the one hand, these frameworks do accelerate the model development process to some extent, but on the other hand, mathematical models and possible post-processing programs often have some problems during the deployment phase and are difficult to debug, especially for some low-level, cost-effective industrial equipment.

### SUMMARY OF INVENTION

The present invention aims to propose a method and a module for customizing a sensor function based on Wasm technology, which do not have the disadvantages of the prior art and have additional advantages. The present invention allows developers to focus only on the logic of model post-processing without having to pay attention to the specific implementation and deployment of the model.

One aspect of the present invention relates to a method for customizing a sensor function based on Wasm technology, which comprises: providing a mathematical model trained for a sensor in a smart device and a post-processing program customized for the mathematical model, wherein the post-processing program is configured to perform post processing on an output data of the mathematical model; deploying the mathematical model in the smart device; compiling the post-processing program into a Wasm program and deploying the Wasm program in the smart device; providing, in the smart device, an interface defined based on WASI specifications, via which the Wasm program can access and operate the sensor.

Another aspect of the present invention relates to a smart device comprising a sensor, wherein a function of the sensor is customized according to the method of the present invention.

Another aspect of the present invention relates to a debugging tool for debugging a mathematical model, which comprises a post-processing module and a compiler stack, wherein the post-processing module generates a post-processing template file for post-processing of the mathematical model, provides the post-processing template file to the compiler stack, and receives an output data of the mathematical model from a runtime running the mathematical model to provide it to a developer, wherein the compiler stack compiles the received post-processing template file into an executable file executable by the runtime, and provides the executable file to the runtime, so that the runtime can generate the output data using the mathematical model.

According to the present invention, Wasm technology is used to enable cross-platform and modular deployment of the post-processing function, thereby enabling the customization of specific function of the sensor in the smart device.

In addition, according to the present invention, developers can easily debug post-processing, and the advantages of no need for compulsorily learning low-level languages or employing specific hardware engineers for debugging, of ensuring execution efficiency and of providing easy portability are obtained accordingly.

### BRIEF DESCRIPTION OF THE DRAWINGS

FIG. 1 shows the creation and training of a mathematical model and the development of a post-processing program.

FIG. 2 shows the development process of a mathematical model according to the prior art.

FIG. 3 shows a debugging tool for debugging a mathematical model according to an embodiment of the present invention.

FIG. 4 shows a flow chart of a process for debugging a mathematical model according to an embodiment of the present invention.

### DETAILED DESCRIPTION

The present invention is further described below in conjunction with the accompanying drawings and specific embodiments so that those skilled in the art can better understand and implement the present invention. However, these embodiments are not intended to limit the present invention. In the absence of conflict, the embodiments of the present invention as well as the technical features in the embodiments may be combined with each other.

In various smart devices of IoT, there are various sensors like image sensors, sound sensors, light sensors etc. These sensors may be used to carry out different purposes depending on the smart device.

In order to use a sensor for a specific purpose, a developer may create and train a corresponding mathematical model in, for example, his/her host. The developer may use a model framework tool to create and train the mathematical model. For example, as the model framework tool, a development platform such as tensorflow, pytorch, and onnx may be used. The sensor may use the mathematical model to perform a calculation or inference on its detection result to obtain a calculation or inference result. The sensor then may output the obtained calculation or inference result as output data in a specific format.

Further, the developer needs to develop a post-processing program for post-processing the output data in, for example, the host. The developer may develop the post-processing program using the programming language he/she is familiar with, for example Python, C/C++, Java, Go, or Rust. By the post-processing program, the smart device may perform the post-process (such as format conversion, etc.) on the output data of the sensor so as to provide a post-processing result containing the desired information.

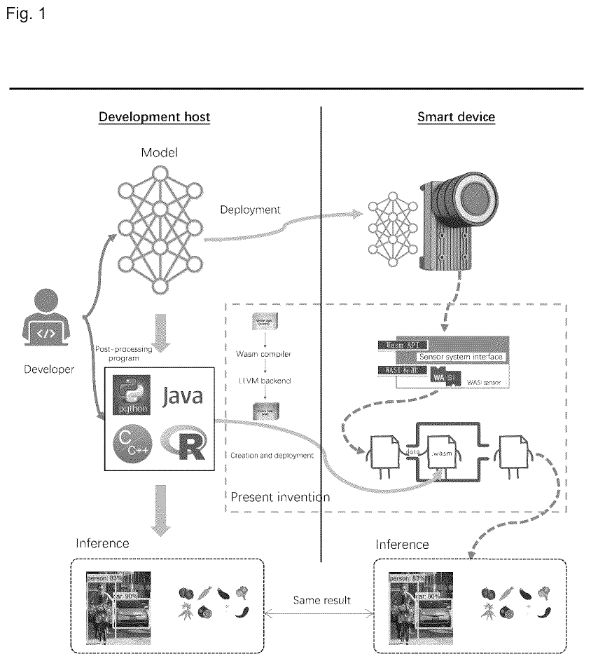

As an example, FIG. 1 shows a case where an IoT device including a camera is used as the smart device. Here, the camera is a sensor in the sense of the present invention. Note that the smart device in the present invention is not limited to the IoT device. According to the technical inspiration of the present invention, those skilled in the art may also apply the present invention to the fields of autonomous driving, equipment detection, environmental detection, logistics detection, security detection, health detection, smart home appliances, retail industry, health care, agriculture, smart cities, etc. Here, not all the application examples of the present invention are listed.

The left side of FIG. 1 shows the creation and training of the mathematical model and the development of the post-processing program of the camera. Here, the mathematical model of the camera may be an object detection model, such as a pedestrian detection model, a face recognition model, etc.

In the prior art, the completed mathematical model and post-processing program are usually directly deployed on the hardware of the smart device. For example, in the example of FIG. 1, they are deployed in a digital signal processor (DSP) of the camera and in a processor of the IoT device respectively. Before deploying the mathematical model, in consideration of the factors such as the power consumption, performance, and resources of the camera, the mathematical model may be lightweighted, for example, by methods such as deep separable convolution, grouped convolution, spatial resolution reduction by adjustable hyperparameters, knowledge distillation, low-rank pruning, and model compression.

The camera uses the mathematical model to perform a calculation or inference its detection result and outputs a calculation or inference result as output data. Then, the IoT device including the camera may post-process the output data of the camera by using the post-processing program to obtain the desired information. The programming environment of the mathematical model may be Python, C/C++, Java, Rust, Go, etc.

However, unlike the prior art, the present invention proposes a technical solution for customizing a sensor function based on Wasm technology. Wasm, or WebAssembly, is a new bytecode format that is gradually being widely recognized due to its portability, small size, and high security. Wasm allows users to write a Wasm program using the language they are familiar with (the programming languages such as python, C/C++, Rust, Java, and Go are currently supported). Then, the Wasm program may run on the web using a virtual machine engine. Wasm technology supports running the Wasm program in a sandbox environment.

As shown in FIG. 1, in the present invention, the post-processing program is compiled into a Wasm program and then deployed in the IoT device (e.g., in the processor) to run in a virtual machine provided by the IoT device. Depending on the programming language of the post-processing program and the embedded environment of the Wasm program, various compilers (for example, LLVM backend) may be used.

In order to enable the Wasm program to carry out functions consistent with those of the post-processing program, the present invention uses the WASI (WebAssembly System Interface) specifications to define a unified sensor system interface for the Wasm program, which is referred to as a WASI sensor here. WASI is a new API system, which is a set of engine-independent, non-Web system-oriented API standards designed for WASM programs, i.e., the standards defining how WASM programs interact with the host environment. For example, the interactions include standard system calls such as those of file system, network stack, time, and random number generator. These system calls are provided to the Wasm program by the predefined API interface, so that the Wasm program can access data resources in the sensor in a sandbox environment. Based on the support of WASI, the Wasm program can also run in non-web environments. As long as the WASI standard is supported, any runtime running the Wasm program can implement system calls in the host environment of the IoT device. The runtime library provides the execution environment of the program, such as memory allocation, variable assignment, function calls, etc. It can also be used to manage threads or processes, and execute explanatory code, dynamic link libraries, shared libraries and the like.

With use of the sensor system interface, the Wasm program may correctly parse the output data generated by the mathematical model of the sensor, and may access and operate the sensor (for example, turn it on, turn it off, perform inference, retrieve result, etc.). As a result, the Wasm program may access and control various functions provided by the sensor with use of the WASI interface through the sandbox boundary, such as obtaining inference data, controlling the life cycle of the sensor, etc. This can not only ensure the security and reliability of the program, but also protect the security of various types of information and equipment. Specifically, when the Wasm program needs to access sensor resources, it can pass the access request to the sensor with use of the interface. The sensor responds to this access request and returns the inference data to the Wasm program.

In the present invention, there may be multiple sensors in the smart device, and each sensor may be provided with at least one mathematical model to implement specific purposes. For example, for the example of FIG. 1, multiple mathematical models may be provided for the camera, including but not limited to a pedestrian detection model, a face recognition model, a text recognition model, a license plate information recognition model, etc.

One post-processing program may be provided for each mathematical model to perform post-processing on the output data of the mathematical model. Of course, one post-processing program may also be provided for multiple mathematical models to perform post-processing on the output data of these mathematical models in combination.

Since the present invention customizes a sensor function based on Wasm technology, the developer may also develop the post-processing program in any language he/she is familiar with, without having to consider what platform the program runs on and how to adjust the program in different devices. In addition, Wasm technology restricts the Wasm program to run in a sandbox environment, so it has high security.

In addition, the present invention provides a sensor system interface based on the WASI specification. The sensor system interface runs in a sandbox environment to control the entire life cycle of the sensor, thereby achieving a higher security. The present invention further implements modular sensor control functions, and the functions of the sensor can be expanded or changed by updating a single Wasm program instead of updating the entire platform.

In summary, the present invention proposes a cross-platform sensor control interface, which the developer can use to locally development and implement the specific post-processing function in conjunction of the mathematical model. Wasm technology enables the post-processing function to be deployed in cross-platform manner and modularly, so that specific function of the sensor can be customized in the smart device.

Hereinafter, the deployment and debugging of Wasm programs according to the present invention will be explained in detail.

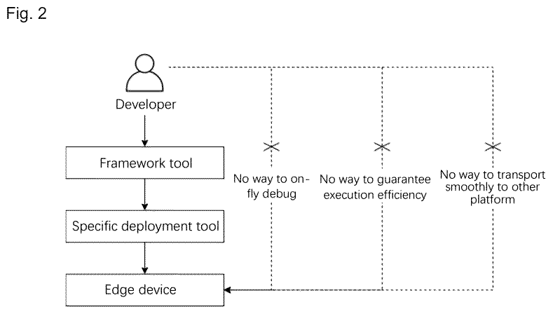

FIG. 2 shows a process of developing a mathematical model using, for example, the Python programming language according to the prior art.

As shown in FIG. 2, first, a mathematical model is created and trained. The model developer can use a model framework tool to train the mathematical model. For example, here, the development platform such as tensorflow, pytorch, and onnx can be used as the model framework tool in the Python programming environment. The Programming tool is not limited to Python, but can also be C/C++, Java, Rust, and Go.

Specifically, the model framework tool is first used to generate an initial model, and then the generated initial model is trained by machine learning. After the training of the initial model is completed, the trained initial model is exported.

Next, depending on the type of model as well as the running environment, the developer may use a corresponding model deployment tool to deploy the completed mathematical model in a specific environment, for example in an edge device such as a personal computer or a smartphone. Here, the edge device may be the camera shown in FIG. 1.

Finally, the deployed mathematical model may be run in the edge device to obtain a calculation or inference result.

However, at present, most developers are only familiar with programming languages based on software framework requirements, (for example, python), but are not familiar with hardware-level programming languages. This makes it difficult for algorithm developers to directly debug Wasm programs, thereby seriously limiting the richness of mathematical models.

Furthermore, even if the mathematical model can be deployed using a hardware platform-specific software stack, such deployment is usually implemented by a series of complex manual operations and is difficult to port to other devices.

Furthermore, developers mainly focus on model design creation without ensuring the efficiency requirements of industrial software.

To solve the above problems, the present invention proposes a debugging tool that may be created in a Docker image so as to provide the developer with out-of-the-box services. As is known to all, development platforms for various programming languages such as Python, Java, Go, and other programming languages can be created using the Docker image. In this disclosure, the Python programming language is used as an example for illustration.

In addition, for the running of the mathematical model, a runtime (e.g., WAMR Runtime) in the edge device (e.g., the smart devices mentioned above) is also necessary to apply the services to a wide range of hardware platforms and smoothly port the entire solution if necessary.

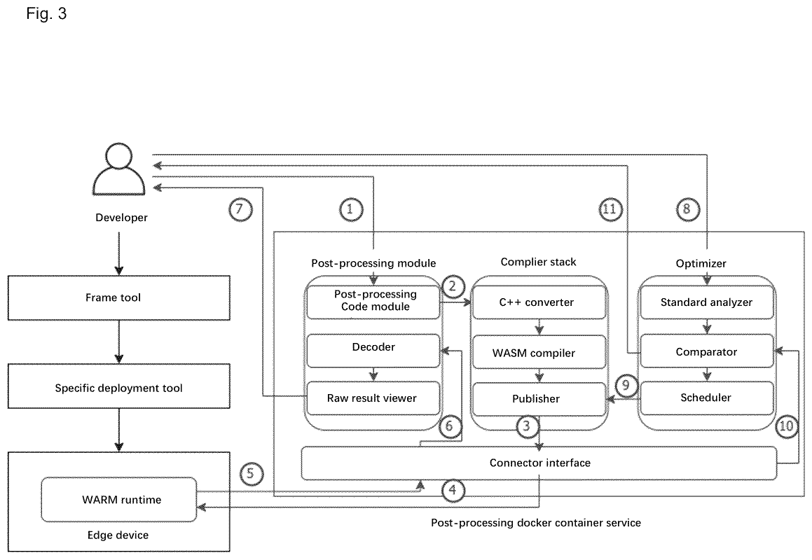

Specifically, FIG. 3 shows a debugging tool according to an embodiment of the present invention, which is used to debug a mathematical model to obtain a higher task metrics, a faster running speed, and a smaller model volume.

According to the present invention, since the developer may, for example, create an entire debugging tool in a Docker image on his/her own host, so as to provide a Docker container service by the Docker image, the developer may provide this service at any time on almost any PC or server operating system platform, such as in an x86 or arm hardware structure. Docker container is an open-source application container engine that allows the developer to package his/her applications and dependent packages into a portable container in a unified way. Specifically, in order to create a debugging tool in a Docker image, for example, a Dockerfile file is written first, which is used to define the environment and the applications in the Docker image. Then, desired debugging tools are added into the Dockerfile file. For example, tools such as gdb, strace, tcpdump, etc. may be selectively added according to the actual requirements. In addition, according to the type of debugging tool used and the requirements of the applications, it may be also necessary to set corresponding environment variables or expose the ports of the container in the Dockerfile file. Then, the Docker image is built. For example, the “docker build -t <image name>” command is executed in the directory containing the Dockerfile file. This command will start building the Docker image. Next, the Docker container is started. For example, the following command is run to start the Docker container: “docker run -it -name <container name><image name>”. Finally, the debugging tool is tested, desired applications are run in the started container, and then the added debugging tools are used for debugging.

The debugging tool according to the present invention may include a post-processing module, a compiler stack and an optional optimizer. The post-processing module may include a post-processing code module, a decoder and a raw data viewer. The compiler stack may include a C++ converter, a WASM compiler and a publisher. The optimizer may include a standard analyzer, a comparator and a scheduler.

According to the present invention, in order to debug the mathematical model, the mathematical model may be run in the edge device using a runtime (e.g., WAMR runtime).

According to the present invention, the Docker running environment of the debugging tool may be connected to the runtime of the edge device via a connector interface, and the connector interface may be used to handle communication protocols, data format conversion, security authentication and other issues, so as to achieve communication and interaction. If necessary, data encryption, identity authentication and other issues need to be considered to ensure the security of communication and the integrity of data. Here, the connection can be automatically performed using various communication protocols, such as wired or wireless communication protocols.

In FIG. 3, as shown in mark \textcircled{1}, the developer may fill Python post-processing codes for post-processing into a template Python file by the post-processing code module. The Python post-processing codes may include instructions for post-processing the output data of the mathematical model. The post-processing codes may be customized by the developer according to the desired post-processing function.

As shown in mark \textcircled{2}, the C++ converter in the compiler stack converts the Python post-processing codes from the post-processing code module into C++ codes. Then, the WASM compiler in the compiler stack converts the C++ codes into a Wasm executable file. Finally, as shown in marks \textcircled{3} and \textcircled{4}, the compiler stack uses the publisher to publish the converted Wasm executable file to the Runtime that runs the mathematical model via the connector interface.

As shown in marks \textcircled{5} and \textcircled{6}, the mathematical model generates calculation or inference result (i.e., output data), and outputs the calculation or inference result to the decoder in the post-processing module via the connector interface. The decoder decodes the calculation or inference result. As shown in mark 7, the raw data viewer in the post-processing module displays the decoded calculation or inference data to the developer in the form of, for example, images, sounds, text, etc. If the calculation or inference result is incorrect or unsatisfactory, the developer may adjust the mathematical model and then repeat the processes as shown in marks \textcircled{1} to \textcircled{7} until a correct or ideal calculation or inference result is obtained.

Optionally, after obtaining the correct or ideal calculation or inference result, the developer may further optimize the mathematical model.

As shown in mark \textcircled{8}, the developer may submit a performance standard, an experimental time cost limit, and the current result to the optimizer. In the optimizer, the standard analyzer parses the performance standard configuration to extract parameters and a time cost, and the comparator compares a standard request and the current result. If the result meets the request, the current result and the time cost are directly returned to the developer as shown in mark \textcircled{11}. Otherwise, as shown in mark \textcircled{9}, the scheduler is started to test various optimization hyperparameters and scheduling strategies, and the publisher is controlled to run the optimized test codes on the edge device in the processes shown in marks \textcircled{3}~\textcircled{5}, and the result of each test case are sent to the comparator in the manner shown in mark \textcircled{10} until a satisfactory value is reached or the best result within the set time is found, and then it is sent back to the developer together with the time cost.

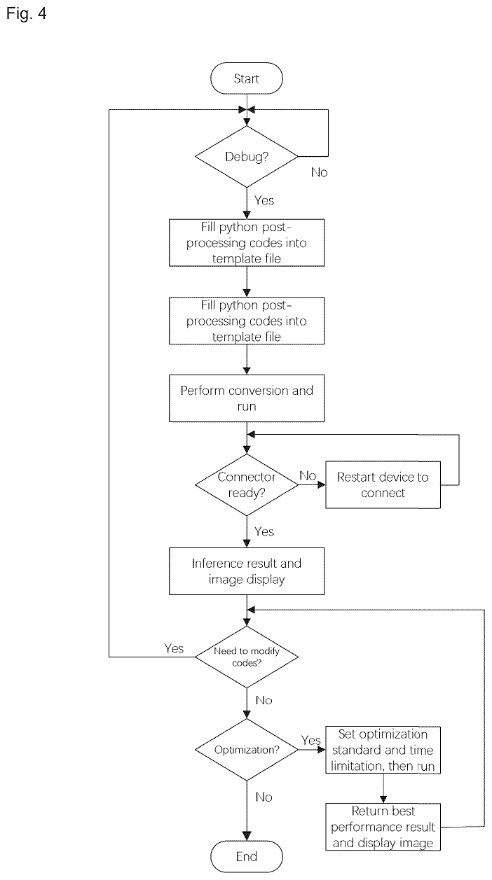

FIG. 4 shows a flow chart of a process for debugging a mathematical model according to an embodiment of the present invention.

It is determined whether debugging is to be started. In the case where the debugging is started, post-processing codes are filled into a template file by the post-processing code module.

Next, the compiler stack converts the template file into an executable file.

Next, it is determined whether the connector interface is ready for connection. If this is not the case, the device is restarted for connection until the connection is successful. In the case of a successful connection, the compiler stack publishes the executable file to the runtime via the connector interface.

Next, the mathematical model outputs the calculation or inference result (i.e., output data) to the post-processing module via the connector interface. The post-processing module then decodes the calculation or inference result and displays the decoded calculation or inference result to the developer.

If the inference result is incorrect or unsatisfactory, the developer may adjust the mathematical model and then repeat the above processes until a correct or ideal calculation or inference result is obtained.

After obtaining the correct or ideal calculation or inference result, it is determined whether the mathematical model is to further optimized.

If the optimization is not required, the debugging process ends immediately.

If the optimization is required, the performance standard configuration, experimental time cost limit, and the current result may be submitted to the optimizer. In the optimizer, the parameters and time limits are extracted, and the standard request and initial result are compared. If the result meets the request, the current result and time cost are directly returned to the developer. Otherwise, the scheduler is started to test various optimization hyperparameters and scheduling strategies, and the publisher is controlled to run the optimized test codes on the edge device, and the result of each test case is sent to the comparator until a satisfactory value is reached or the best result within the set time is found, and then it is sent back to the developer together with the time cost. At this point, the debugging process ends.

According to the present invention, the following configurations may be adopted.

(1) A method for customizing a sensor function based on Wasm technology, comprising: providing a mathematical model trained for a sensor in a smart device and a post-processing program customized for the mathematical model, wherein the post-processing program is configured to perform post processing on an output data of the mathematical model;
deploying the mathematical model in the smart device;
compiling the post-processing program into a Wasm program and deploying the Wasm program in the smart device;
providing, in the smart device, an interface defined based on WASI specifications, via which the Wasm program can access and operate the sensor.

(2) The method according to (1) above, wherein the Wasm program has a post-processing function consistent with that of the post-processing program.

(3) The method according to (1) above, wherein the mathematical model is deployed in the sensor.

(4) The method according to (1) above, wherein the Wasm program is run in a virtual machine provided by the smart device.

(5) The method according to (1) above, wherein the post-processing is a format conversion of the output data.

(6) The method according to (1) above, wherein the post-processing program and the mathematical model are developed using any one of the programming languages selected from Python, C/C++, Java, Rust and Go.

(7) The method according to (1) above, wherein in the step of deploying the mathematical model in the smart device, the method further comprises a step of debugging the mathematical model, the debugging comprising:
running the mathematical model in a suitable runtime; creating a debugging tool in a Docker image, and running the debugging tool in a Docker running environment;
by the debugging tool, filling post-processing codes for the post-processing in a template file;
by the debugging tool, compiling the template file into an executable file executable by the runtime;
by the runtime, receiving the executable file from the Docker running environment, and executing the executable file, so as to generate the output data using the mathematical model;
by the debugging tool, receiving the output data from the runtime, decoding the output data, and providing the decoded output data to a developer;
by the developer, adjusting the mathematical model in case the output data is incorrect;
repeating the above steps until a correct output data is obtained.

(8) The method according to (7) above, wherein in the compiling of the executable file,
the debugging tool converts the template file into C++ codes, converts the C++ codes into the executable file, and publishes the executable file to the runtime.

(9) According to the method described in (7) above, wherein after the correct output data is obtained, the debugging tool analyzes a standard request set by the developer, compares the standard request with the output data, and, if result of the comparison is unsatisfactory, tests a plurality of scheduling strategies and finds an optimal scheduling strategy therefrom.

(10) The method according to (7) above, wherein the runtime is provided by the smart device.

(11) The method according to (7) above, wherein the Docker running environment is provided by the developer's host.

(12) The method according to (7) above, wherein the Docker image creates a development environment for any one of the programming languages of Python, C/C++, Java, Rust and Go, and the mathematical model, the debugging tool and the post-processing program are developed or created using the same programming language.

(13) A smart device comprising a sensor,
wherein the function of the sensor is customized according to the method according to any one of (1) to (12) above.

(14) A debugging tool for debugging a mathematical model, comprising a post-processing module and a compiler stack,
wherein the post-processing module generates a post-processing template file for post-processing the mathematical model, provides the post-processing template file to the compiler stack, and receives an output data of the mathematical model from a runtime running the mathematical model and provides it to a developer.
wherein the compiler stack compiles the received post-processing template file into an executable file executable by the runtime, and provides the executable file to the runtime, so that the runtime can generate the output data using the mathematical model.

(15) The debugging tool according to (14) above, wherein the debugging tool and the mathematical model are developed or created using the same programming language.

(16) The debugging tool according to (14) above, wherein the post-processing module comprises: a post-processing code module configured to generate the post-processing template file and provide it the compiler stack;
a decoder configured to receive the output data of the mathematical model from the runtime, and decode the output data; and
a raw result viewer configured to provide the decoded output data to the developer.

(17) The debugging tool according to (14) above, wherein the compiler stack comprises: a C++ converter configured to convert the post-processing template file into C++ code;
a WASM compiler configured to convert the C++ code into the executable file; and
a publisher configured to publish the executable file to the runtime.

(18) The debugging tool according to (14) above, further comprising an optimizer, wherein the optimizer comprises:
a standard analyzer configured to analyze a standard request set by the developer;
a comparator configured to compare the standard request with the output data of the mathematical model; and
a scheduler configured to test a plurality of scheduling strategies and find an optimal scheduling strategy therefrom if result of the comparison is unsatisfactory.

(19) The debugging tool according to (14) above, wherein
the debugging tool is created in a Docker image.

It will be apparent to those skilled in the art that the invention is not limited to the details of the exemplary embodiments described above and that the invention can be implemented in other specific forms without departing from the spirit or essential features of the invention. Therefore, the embodiments should be considered exemplary and non-limiting in all respects, and the scope of the invention is defined by the appended claims rather than the foregoing description, and it is intended that all variations falling within the meaning and scope of the equivalent elements of the claims be included in the invention. Any reference numeral in a claim should not be considered as limiting the claim to which it relates.

In addition, it should be understood that although the present specification is described according to the embodiments, not every embodiment contains only one independent technical solution. This description of the specification is only for the sake of clarity. Those skilled in the art should regard the specification as a whole. The technical solutions in each embodiment may also be appropriately combined to form other embodiments that can be understood by those skilled in the art.

1. A method for customizing a sensor function based on Wasm technology, comprising:
providing a mathematical model trained for a sensor in a smart device and a post-processing program customized for the mathematical model, wherein the post-processing program is configured to perform post processing on an output data of the mathematical model;
deploying the mathematical model in the smart device;
compiling the post-processing program into a Wasm program and deploying the Wasm program in the smart device;
providing, in the smart device, an interface defined based on WASI specifications, via which the Wasm program can access and operate the sensor.

2. The method according to claim 1, wherein the Wasm program has a post-processing function consistent with that of the post-processing program.

3. The method according to claim 1, wherein the mathematical model is deployed in the sensor.

4. The method according to claim 1, wherein the Wasm program is run in a virtual machine provided by the smart device.

5. The method according to claim 1, wherein the post-processing is a format conversion of the output data.

6. The method according to claim 1, wherein the post-processing program and the mathematical model are developed using any one of the programming languages selected from Python, C/C++, Java, Rust and Go.

7. The method according to claim 1, wherein in the step of deploying the mathematical model in the smart device, the method further comprises a step of debugging the mathematical model, the debugging comprising:
running the mathematical model in a suitable runtime;
creating a debugging tool in a Docker image, and running the debugging tool in a Docker running environment;
by the debugging tool, filling post-processing code for the post-processing in a template file;
by the debugging tool, compiling the template file into an executable file executable by the runtime;
by the runtime, receiving the executable file from the Docker running environment, and executing the executable file, so as to generate the output data using the mathematical model;
by the debugging tool, receiving the output data from the runtime, decoding the output data, and providing the decoded output data to a developer;
by the developer, adjusting the mathematical model in case the output data is incorrect;
repeating the above steps until a correct output data is obtained.

8. The method according to claim 7, wherein in the compiling of the executable file,
the debugging tool converts the template file into C++ code, converts the C++ code into the executable file, and publishes the executable file to the runtime.

9. The method according to claim 7, wherein after the correct output data is obtained, the debugging tool analyzes a standard request set by the developer, compares the standard request with the output data, and, if result of the comparison is unsatisfactory, tests a plurality of scheduling strategies and finds an optimal scheduling strategy therefrom.

10. The method according to claim 7, wherein the runtime is provided by the smart device.

11. The method according to claim 7, wherein the Docker running environment is provided by the developer's host.

12. The method according to claim 7, wherein the Docker image creates a development environment for any one of the programming languages of Python, C/C++, Java, Rust and Go, and the mathematical model, the debugging tool and the post-processing program are developed or created using the same programming language.

13. A smart device comprising a sensor, wherein the sensor has function customized using the method according to claim 1.

14. A debugging tool for debugging a mathematical model, comprising a post-processing module and a compiler stack,
wherein the post-processing module generates a post-processing template file for post-processing of the mathematical model, provides the post-processing template file to the compiler stack, and receives an output data of the mathematical model from a runtime running the mathematical model to provide it to a developer, wherein the compiler stack compiles the received post-processing template file into an executable file executable by the runtime, and provides the executable file to the runtime, so that the runtime can generate the output data using the mathematical model.

15. The debugging tool according to claim 14, wherein the debugging tool and the mathematical model are developed or created using the same programming language.

16. The debugging tool according to claim 14, wherein the post-processing module comprises:
a post-processing code module configured to generate the post-processing template file and provide it the compiler stack;
a decoder configured to receive the output data of the mathematical model from the runtime, and decode the output data; and
a raw result viewer configured to provide the decoded output data to the developer.

17. The debugging tool according to claim 14, wherein the compiler stack comprises:
a C++ converter configured to convert the post-processing template file into C++ code;
a WASM compiler configured to convert the C++ code into the executable file; and
a publisher configured to publish the executable file to the runtime.

18. The debugging tool according to claim 14, which further comprises an optimizer comprising:
a standard analyzer configured to analyze a standard request set by the developer;
a comparator configured to compare the standard request with the output data of the mathematical model; and
a scheduler configured to test a plurality of scheduling strategies and find an optimal scheduling strategy therefrom if result of the comparison is unsatisfactory.

19. The debugging tool according to claim 14, wherein the debugging tool is created in a Docker image.
